(19) United States
(12) Patent Application Publication
(10) Pub. No.: US 2002/0083238 A1
(43) Pub. Date: Jun. 27, 2002

(54) Apparatus and method of storing/reproducing data

(75) Inventors: Hideyuki Naka, Kanagawa-ken (JP); Jun Wakasugi, Kanagawa-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Saiwai-ku (JP)

(21) Appl. No.: 10/026,795

(22) Filed: Dec. 27, 2001

(30) Foreign Application Priority Data
Dec. 27, 2000 (JP) 2000-398664

(51) Int. Cl. G06F 12/00

(52) U.S. Cl. 710/68; 711/171; 711/172

(57) ABSTRACT

An apparatus for storing and reproducing data includes a detector to detect available space in a storage medium in which target data is configured to be stored, an estimator to estimate a compressed quantity of the target data if the target data is compressed at an initial bit rate, a comparator to compare the detected available space with the estimated quantity and provide a comparison result, and a DSP to determine a bit rate according to the comparison result, compress the target data at the determined bit rate, and configured to store the compressed data in the storage medium.

### CROSS REFERENCE TO RELATED APPLICATIONS

This application is based upon and claims the benefit of priority from the prior Japanese Patent Application No. 2000-398664 filed on Dec. 27, 2000, the entire contents of which are incorporated herein by reference.

### BACKGROUND OF THE INVENTION

1. Field of the Invention

The present invention relates to an apparatus for storing digital data in and reproducing digital data from a storage medium such as a semiconductor memory and a method of storing digital data in and reproducing digital data from a storage medium.

2. Description of the Related Art

There are apparatuses to store digital data such as audio and video data in and reproduce from storage media such as semiconductor memories including Flash Programmable Read-Only Memories (PROMs) and Electrically Erasable Programmable Read-Only Memories (EPROMs). The structure and operation of a storing-reproducing apparatus according to a related art will be explained with reference to FIGS. 1, 2, and 3.

FIG. 1 shows the structure of the storing-reproducing apparatus according to the related art.

The apparatus has a Digital Signal Processor (DSP) 10, a Random Access Memory (RAM) 11, a Read-Only Memory (ROM) 12, an I/O controller 13, a memory controller 14, and an audio unit 15.

The DSP 10 compresses original data and stores the compressed data in a storage medium 20 such as a semiconductor memory. When reproducing the original data from the storage medium 20, the DSP 10 decompresses the stored data. The DSP 10 follows programs stored in the ROM 12, to carry out various control operations. For example, the DSP 10 loads data necessary for compression and decompression operations from the ROM 12 into the RAM 11. The RAM 11 secures a work area for temporarily storing programs and data used by the DSP 10. The ROM 12 stores various programs including a storing program and a reproducing program and various pieces of data including bit rates. The I/O controller 13 controls the input and output of digital data and control information. The I/O controller 13 receives external data and control information through an external interface and transfers the received data and information to the DSP 10, RAM 11, and ROM 12 through a bus 19. The memory controller 14 controls the storage medium 20 and transfers digital data between the storage medium 20 and the DSP 10, RAM 11, and ROM 12 through the bus 19. The audio unit 15 plays data such as voice data.

The storing and reproducing operations of the related art will be explained with reference to FIGS. 2 and 3.

FIG. 2 shows the storing operation of digital data in the storage medium 20 carried out by the related art. The digital data is received from an external interface through the I/O controller 13. The DSP 10 loads a bit rate from the ROM 12 into the RAM 11, and based on the bit rate, compresses the digital data. The compressed data is stored in the storage medium 20 through the memory controller 14.

FIG. 3 shows the reproducing operation of digital data from the storage medium 20 carried out by the related art. Compressed digital data is loaded from the storage medium 20 into the RAM 11 through the memory controller 14. The DSP 10 decompresses the read data according to a bit rate written when the data was stored in the storage medium 20 and provides the decompressed data to an external interface through the I/O controller 13. If the decompressed data is audio data, it is played by the audio unit 15.

To efficiently use the limited storing space in the storage medium 20, the DSP 10 of the related art compresses input data according to a preset bit rate (bps) and stores the compressed data in the storage medium 20. A problem caused by employing such a preset fixed bit rate to compress data will be explained.

FIG. 4 schematically shows a total capacity of the storage medium 20 and data already stored therein. Data 1 and 2 are to be stored in an available space of the storage medium 20. The data 1 can completely be stored in the storage medium 20 but the data 2 cannot be completely be stored therein because the available space of the storage medium 20 is insufficient for the data 2.

This means that a compression ratio realized by the preset bit rate is insufficient to store the data 2 in the available space of the storage medium 20. In this case, the user must end the storing operation with only part of the data 2 having been stored in the storage medium 20, or must newly set a lower bit rate so that the data 2 may further be compressed and completely be stored in the storage medium 20.

Newly setting a bit rate is troublesome work for the user. Lowering the preset bit rate may increase data quantity able to be stored in the storage medium 20 but it deteriorates the quality of the data stored. FIG. 5 is a table showing various types of digital data involving different bit rate limitations. For example, MPEG Audio Layer 3 (MP3) data requires a bit rate of 128 kbps if the data must be kept at Compact Disc (CD) quality.

To solve the problem of the related art, the present invention provides an apparatus for and a method of automatically optimizing the bit rate for storing data in a storage medium and automatically changing the bit rate to increase the quantity of storable data.

### SUMMARY OF THE INVENTION

According to an aspect of the present invention, an apparatus for storing and reproducing data includes a detector to detect available space in a storage medium in which target data is configured to be stored, an estimator to estimate a compressed quantity of the target data if the target data is compressed at an initial bit rate, a comparator to compare the detected available space with the estimated quantity and provide a comparison result, and a DSP to determine a bit rate according to the comparison result, compress the target data at the determined bit rate, and configured to store the compressed data in the storage medium.

According to another aspect of the present invention, a method of storing and reproducing data includes detecting available space in a storage medium in which target data is configured to be stored, estimating a compressed quantity of the target data if the target data is compressed at an initial bit rate, comparing the detected available space with the estimated quantity, providing a comparison result, determining a bit rate according to the comparison result, compressing the target data at the determined bit rate, and being configured to store the compressed data in the storage medium.

### BRIEF DESCRIPTION OF THE DRAWINGS

The objects, features, and advantages of the present invention will become more apparent from the following description of the preferred embodiments when taken in conjunction with the accompanying drawings, in which:

FIG. 1 shows the structure of a storing-reproducing apparatus according to a related art;

FIG. 2 shows a storing operation of the apparatus of FIG. 1;

FIG. 3 shows a reproducing operation of the apparatus of FIG. 1;

FIG. 4 shows data storing states in a storage medium according to a storing-reproducing apparatus of a related art;

FIG. 5 is a table showing various bit rates and corresponding storage times;

FIG. 6 shows the structure of a storing-reproducing apparatus according to an embodiment of the present invention;

FIG. 7 is a flowchart showing a variable bit rate controlling operation according to the embodiment;

FIG. 8 shows data storing states in a storage medium according to the embodiment;

FIG. 9 shows data storing states in a storage medium according to a modification 1 of the embodiment;

FIG. 10 is a flowchart showing a recompression operation according to a modification 4 of the embodiment; and

FIG. 11 shows data storing states in a storage medium according to the modification 4.

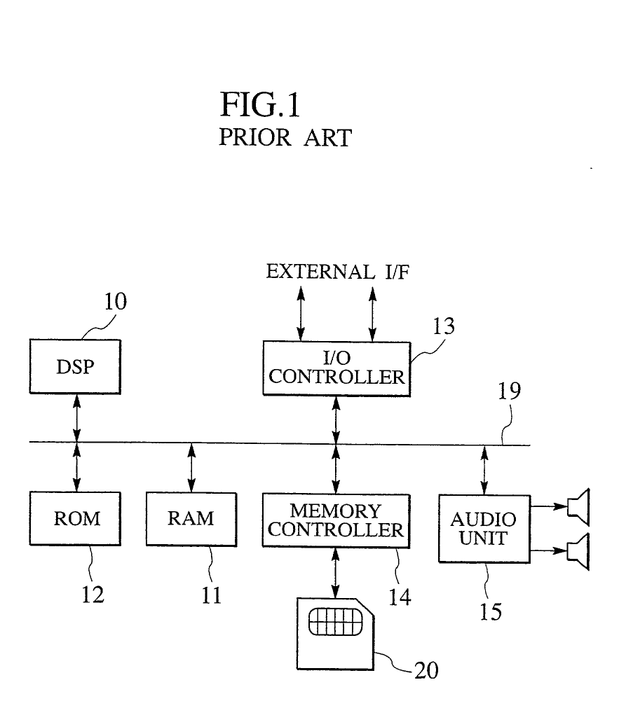

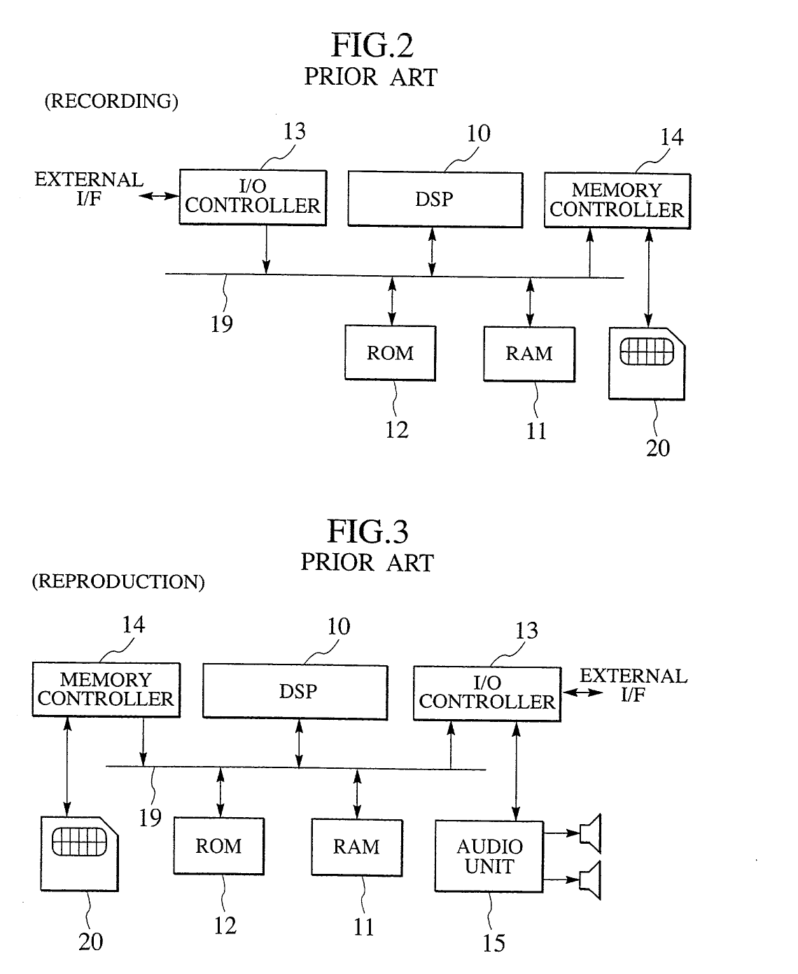

### DETAILED DESCRIPTION OF EMBODIMENTS

Various embodiments of the present invention will be described with reference to the accompanying drawings.

(Structure of Apparatus)

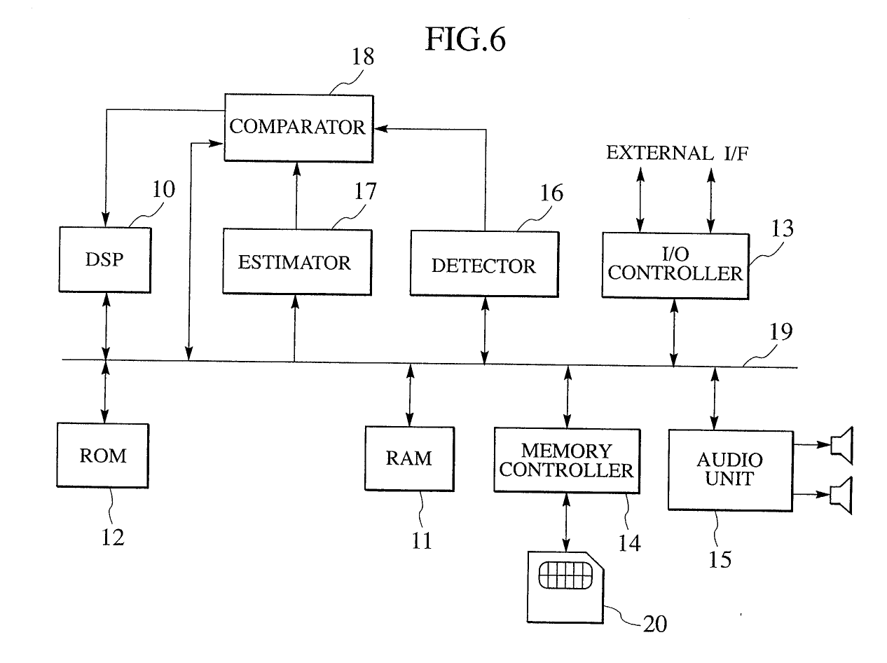

As shown in FIG. 6, the apparatus for storing and reproducing data of the first embodiment has a DSP 10, a RAM 11, a ROM 12, an I/O controller 13, a memory controller 14, an audio unit 15, a detector 16, an estimator 17, and a comparator 18.

The DSP 10 compresses data and stores the compressed data in a storage medium 20 such as a semiconductor memory. When reproducing original data from the data stored in the storage medium 20, the DSP 10 decompresses the stored data. The DSP 10 follows programs stored in the ROM 12, to carry out various control operations. For example, the DSP 10 loads a bit rate controlling program and data such as a bit rate necessary for executing a bit rate controlling operation from the ROM 12 into the RAM 11. The RAM 11 secures a work area for temporarily storing programs and data used by the DSP 10 to execute various operations. The ROM 12 stores various programs including a storing program, a reproducing program, and the bit rate controlling program and various pieces of data including bit rates. The I/O controller 13 controls operations to input and output digital data and control information. The I/O controller 13 receives external data and control information from an external interface and transfers the received data and information to the DSP 10, RAM 11, and ROM 12 through a bus 19. The memory controller 14 controls the storage medium 20 and transfers data between the storage medium 20 and the DSP 10, RAM 11, and ROM 12 through the bus 19. The audio unit 15 provides data such as voice data. The detector 16 detects and calculates available space in the storage medium 20 through the memory controller 14 and informs the comparator 18 of the calculated available space. The estimator 17 receives, from an external medium or an external interface, the quantity of target data to be stored in the storage medium 20, estimates the compressed quantity of the target data if the target data is compressed at an initially set bit rate, and informs the comparator 18 of the estimated result. The comparator 18 compares the available space detected by the detector 16 with the estimated result from the estimator 17 and provides the DSP 10 with a comparison result directly or through the bus 19.

A storing-reproducing apparatus with this structure is capable of automatically optimizing the bit rate in order to completely store target data in the available space in the storage medium 20, thereby improving the operability of the apparatus for the user.

(Operation of the Apparatus)

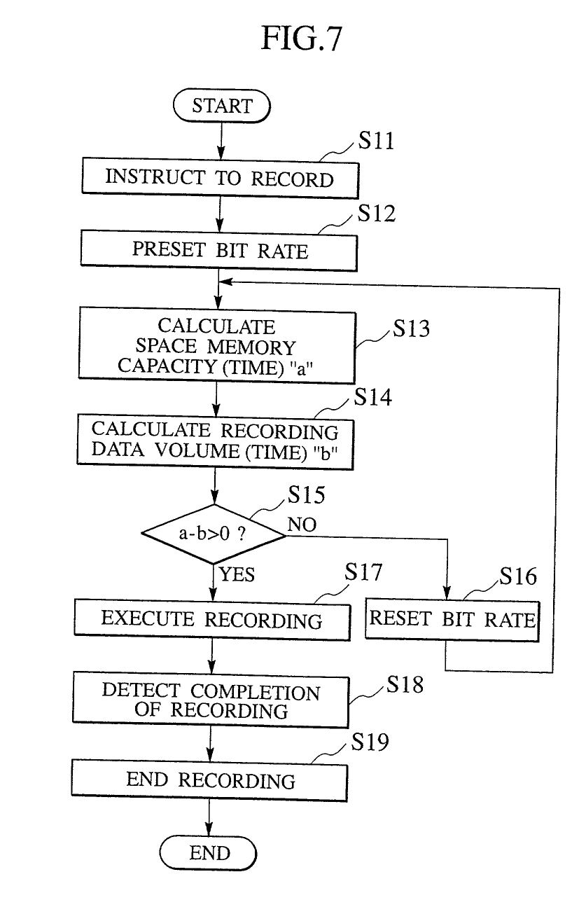

FIG. 7 shows a variable bit rate controlling operation carried out by the storing-reproducing apparatus of FIG. 6.

(A) In step S11, the DSP 10 detects that target data to be stored in the storage medium 20 has been entered and executes a storage start instruction.

(B) In step S12, the DSP 10 sets an initial bit rate to be used to compress the target data.

(C) In step S13, the detector 16 detects and calculates available space “a” (bits) in the storage medium 20 and informs the comparator 18 of the available space.

(D) In step S14, the estimator 17 estimates a compressed quantity “b” (bits) of the target data if the target data is compressed at the initial bit rate, and informs the comparator 18 of the estimated quantity. If the target data is on a disk such as a CD (compact disc), the estimator 17 acquires index information from a TOC (table of contents) of the disc, and according to the acquired information, estimates the compressed quantity.

(E) In step S15, the comparator 18 compares the detected available space “a” with the estimated quantity “b” and informs the DSP 10 of a comparison result directly or through the bus 19. If the comparison result satisfies a condition of “a-b>0” to indicate that the available space “a” in the storage medium 20 is greater than the estimated quantity “b,” the DSP 10 compresses and stores the target data in step S17 at the initially set bit rate. If the comparison result indicates that the available space “a” is less than the estimated quantity “b,” the DSP 10 reset the bit rate in step S16.

(F) In step S16, the DSP 10 reduces the bit rate relative to the initial bit rate set in step S12 and feeds the reduced bit rate back to the estimator 17. Steps S13 to S15 are repeated until the condition of “a-b>0” is satisfied.

(G) In step S17, the DSP 10 compresses the target data at the set bit rate and stores the compressed data in the storage medium 20.

(H) Step S18 determines that the target data has been stored completely in the storage medium 20, and step S19 ends the storing operation.

According to this embodiment, the DSP 10 sets an initial bit rate in step S12. In this step S12, the DSP 10 may set a maximum allowable bit rate as the initial bit rate. If step S15 determines that the available space in the storage medium 20 is smaller than the estimated quantity according to the output of the comparator 18, the DSP 10 in step S16 reduces the initial bit rate from the maximum allowable bit rate to the next highest one. This technique enables the target data to be stored at a bit rate proximate to the initial bit rate. Namely, this technique stores the target data at the highest possible quality.

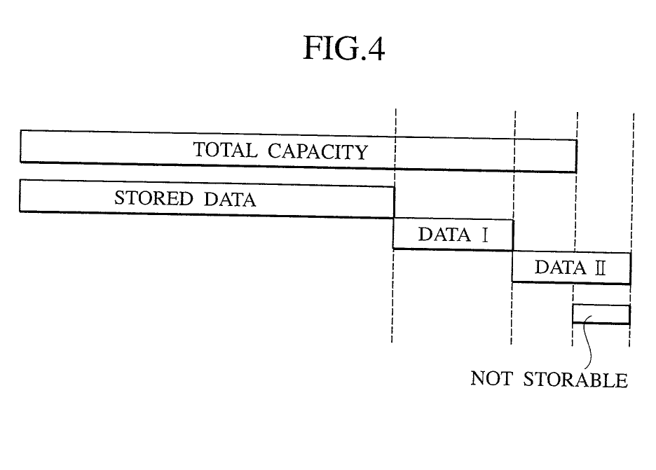

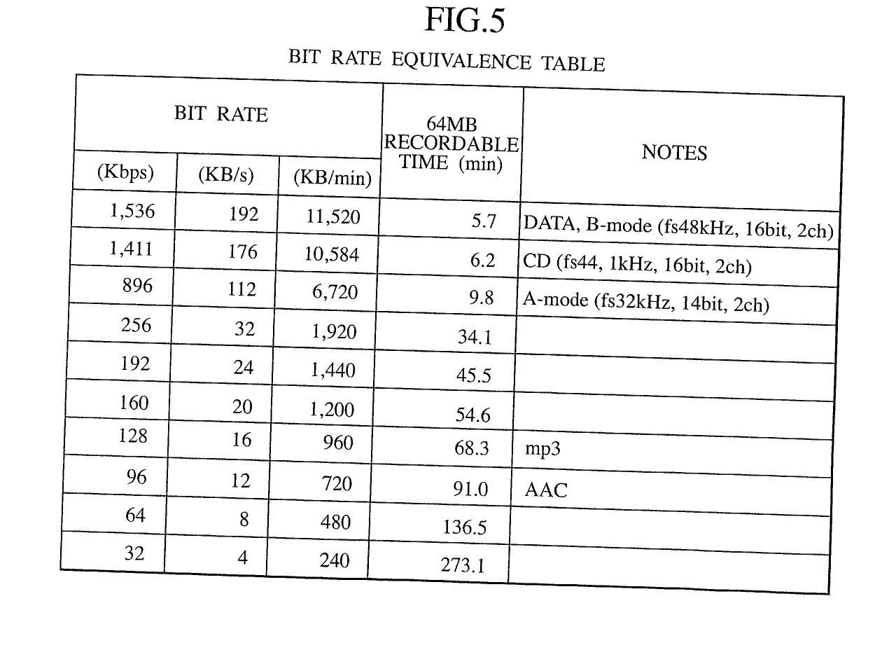

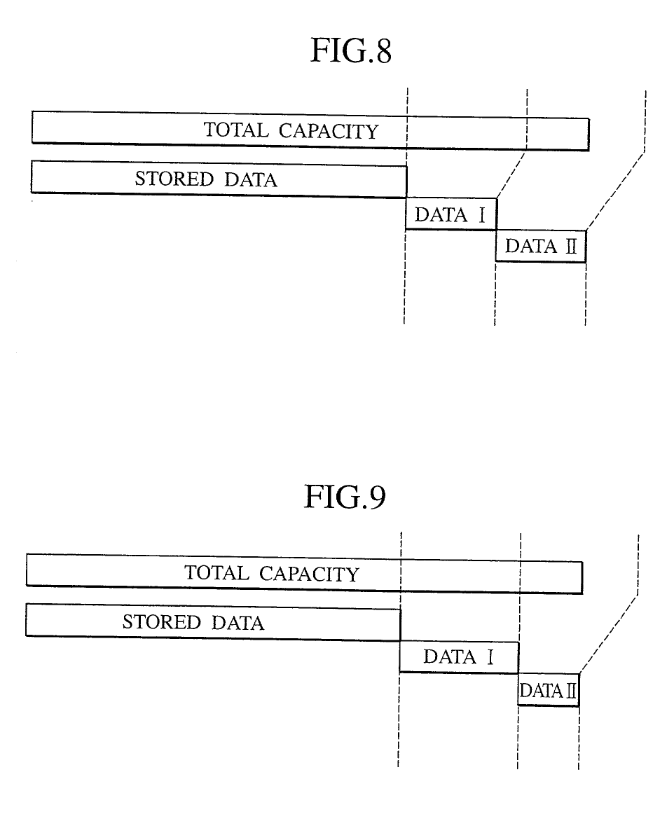

FIG. 8 shows data storing states in the storage medium 20 and corresponds to FIG. 4. In FIG. 8, the storage medium 20 already holds some data, and new data 1 and data 2 are to be stored in the storage medium 20 using the apparatus of FIG. 6. In this case, the DSP 10 carries out the variable bit rate controlling operation on the data 1 and data 2 so that the data 1 and data 2 are completely stored in the storage medium 20.

The storing-reproducing apparatus and method of this embodiment automatically repeat the bit rate setting operation improving the operability of the apparatus for the user.

The apparatus and method of this embodiment gradually reduce the maximum allowable bit rate to an optimum one for storing target data at the highest possible quality in the available space of a storing medium.

(Modification 1)

A modification 1 based on the embodiment of FIGS. 6 and 7 will be explained. According to the embodiment of FIGS. 6 and 7, the DSP 10 sets a new bit rate for the whole of target data to be stored in the storage medium 20. Instead, the modification 1 newly sets a bit rate for each target data file or target data stream to be stored in the storage medium 20. In this case, before executing the variable bit rate controlling operation, the user sets the priorities of target data files or target data streams to be stored in the storage medium 20.

For example, target data to be stored in the storage medium 20 may be audio data consisting of several tracks (files or streams). In this case, the user selects the tracks to be stored and gives priorities to the selected tracks according to qualities with which the selected tracks must be stored. Thereafter, the variable bit rate controlling operation is started. If the comparator 18 determines, in step S15, that available space in the storage medium 20 is less than the quantity of data to store, the DSP 10 allocates, in step S16, higher bit rates to tracks having higher priorities. In this way, the modification 1 is capable of storing data such as audio data consisting of a plurality of tracks (files or streams) at different qualities.

FIG. 9 shows data storing states in a storage medium and corresponds to FIG. 4. In FIG. 9, the storage medium already holds some data, and new data 1 and data 2 are going to be stored in the storage medium according to the modification 1. The DSP 10 compresses the data 1 at an initial bit rate or a bit rate close to the initial bit rate, sets a lower bit rate for the data 2, and compresses the data 2 at the lower bit rate, so that the data 1 and data 2 may completely be stored in an available space of the storage medium. In this way, the modification 1 allocates higher bit rates to data files or data streams that must maintain high qualities, compresses the data at the allocated bit rates, and stores the compressed data in a storage medium.

The storing-reproducing apparatus and method according to the modification 1 are capable of setting different bit rates for data files or data streams to be stored in a storage medium. Namely, the modification 1 is capable of allocating optimum bit rates to the data pieces to be store, respectively.

(Modification 2)

A modification 2 based on the embodiment of FIGS. 6 and 7 will be explained. According to the embodiment of FIGS. 6 and 7, in step S16 the DSP 10 changes the initial bit rate set in step S12 to a new bit rate. Instead, the modification 2 prepares a plurality of bit rates in advance and allows the user to choose the preferred bit rate from among them. Alternatively, the modification 2 makes the DSP 10 choose automatically, in step S16, the optimum bit rate from among the prepared bit rates.

The modification 2 is capable of allowing the user to store data at a required bit rate.

(Modification 3)

A modification 3 based on the embodiment of FIGS. 6 and 7 will be explained. According to the embodiment of FIGS. 6 and 7, the DSP 10 changes, in step S16, the initial bit rate set in step S12 to a new bit rate. Instead, the modification 3 prepares a plurality of bit rates in advance and chooses, in step S16, the highest possible bit rates, i.e., one that realizes the highest level of quality for target data and is appropriate to the available space in a storage medium in which target data is to be stored. The modification 3 successively reduces the initial bit rate from among the prepared bit rates to fined one suitable for an available space in a storage medium. The modification 3 may give priority to data pieces already stored in the storage medium and allocate higher bit rates to data pieces having higher priorities.

The modification 3 is capable of changing bit rates to store data in a storage medium, depending on an available space in the storage medium.

(Modification 4)

A modification 4 based on the embodiment of FIGS. 6 and 7 will be explained. According to the embodiment of FIGS. 6 and 7, the DSP 10 sets, in step S16, a new bit rate so that target data is compressed and stored in the available space of a storage medium. Instead, the modification 4 recompresses data already stored in a storage medium, to increase available space in the storage medium and completely store every piece of target data in the storage medium.

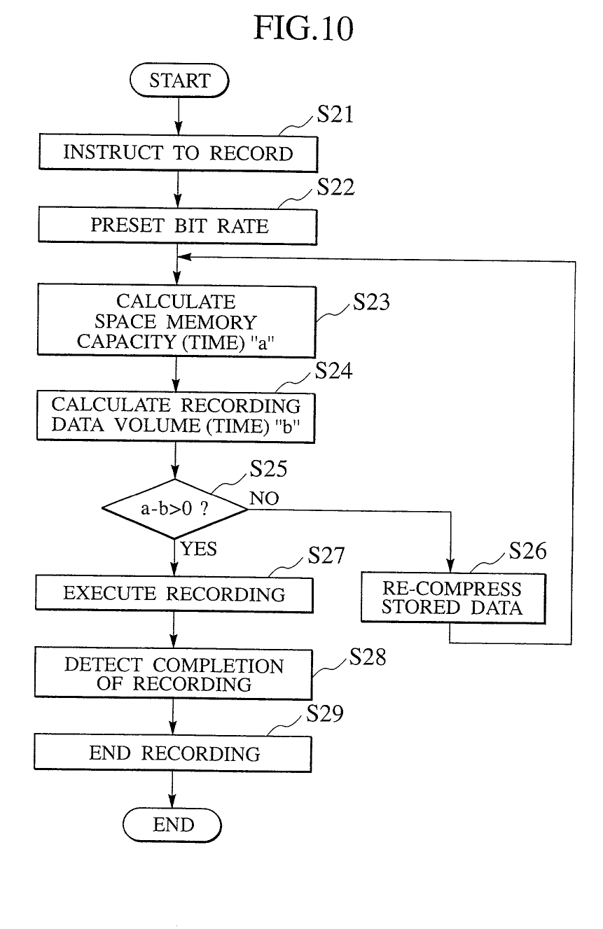

The recompression control operation according to the modification 4 will be explained with reference to FIG. 10.

(A) In step S21, the DSP 10 detects that target data to be stored in a storage medium is ready and executes a storage start instruction.

(B) In step S22, the DSP 10 sets an initial bit rate to compress the target data.

(C) In step S23, the detector 16 detects and calculates available space “a” (bits) in the storage medium and informs the comparator 18 of the available space.

(D) In step S24, the estimator 17 estimates a compressed quantity “b” (bits) of the target data if the target data is compressed at the initial bit rate, and informs the comparator 18 of the estimated quantity.

(E) In step S25, the comparator 18 compares the detected available space “a” with the estimated quantity “b” and sends a comparison result to the DSP 10 directly or through the bus 19. If the comparison result satisfies a condition of “a-b>0” to indicate that the available space “a” is greater than the estimated quantity “b,” the DSP 10 compresses and stores the target data at the initial bit rate in step S27. If the comparison result indicates that the available space “a” is smaller than the estimated quantity “b,” the DSP 10 recompresses the data already stored in the storage medium in step S26.

(F) In step S26, the DSP 10 recompresses the data stored in the storage medium at a lower bit rate and feeds a result of the recompression back to the estimator 17. The lower bit rate for the recompression is chosen so as not to be lower than a minimum bit rate necessary to maintain the quality of the recompressed data. Steps S23 to S25 are repeated until the condition of “a-b>0” is satisfied.

(G) In step S27, the DSP 10 compresses the target data at the initial bit rate set in step S22 and stores the compressed data in the storage medium.

(H) Step S28 determines that the target data has completely been stored in the storage medium, and step S29 ends the storing operation.

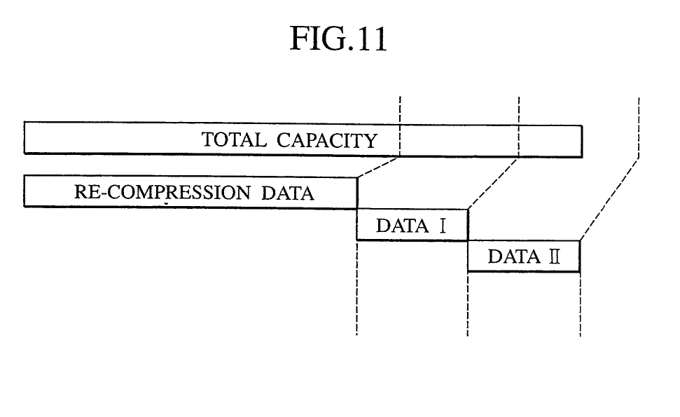

FIG. 11 shows data storing states in a storage medium and corresponds to FIG. 4. In FIG. 11, the DSP 10 recompresses data already stored in the storage medium at a lower bit rate to increase the available space in the storage medium so that data 1 and data 2 may completely be stored in the storage medium at an initially set bit rate.

If the compressed quantity of the target data to be stored in a storage medium is greater than the available space in the storage medium, the modification 4 automatically, variably, and optimally recompresses data already stored in the storage medium so that the target data may completely be stored in the storage medium. This improves the operability of the storing-reproducing apparatus for the user.

As explained above, any one of the storing-reproducing apparatuses and methods according to the embodiment and modifications of the present invention is capable of repeatedly, automatically, variably, and optimally setting a proper bit rate to store target data in a storage medium and recompressing data already stored in the storage medium so that the target data may completely be stored in the storage medium.

What is claimed is:

1. An apparatus for storing and reproducing data, comprising:
a detector to detect available space in a storage medium in which target data is configured to be stored;
an estimator to estimate a compressed quantity of the target data if the target data is compressed at an initial bit rate;
a comparator to compare the detected available space with the estimated compressed quantity and provide a comparison result; and
a DSP to determine a bit rate according to the comparison result, compress the target data at the determined bit rate, and configured to store the compressed data in the storage medium.

2. The apparatus of claim 1, wherein the DSP gradually reduces the initial bit rate, to determine the bit rate at which to compress the target data.

3. The apparatus of claim 1, wherein the DSP determines a bit rate for each data file or each data stream contained in the target data when compressing the target data.

4. The apparatus of claim 3, wherein the DSP determines a bit rate for each data file or each data stream contained in the target data according to a priority given to the data file or data stream when compressing the target data.

5. The apparatus of claim 1, wherein the DSP determines the bit rate to compress the target data from among a plurality of bit rates prepared in advance.

6. The apparatus of claim 1, wherein the DSP is configured to allocate the highest bit rate of the bit rates prepared in advance to the target data and gradually lowers the bit rate as available space in the storage medium reduces.

7. The apparatus of claim 1, wherein the DSP is configured to recompress data already stored in the storage medium at a lower bit rate, so that the target data can be completely stored in the storage medium.

8. A method of storing and reproducing data, comprising:
detecting available space in a storage medium in which target data is configured to be stored;
estimating a compressed quantity of the target data if the target data is compressed at an initial bit rate;
comparing the detected available space with the estimated compressed quantity and providing a comparison result; and
determining a bit rate according to the comparison result, compressing the target data at the determined bit rate, and being configured to store the compressed data in the storage medium.

9. The method of claim 8, wherein said determining the bit rate includes gradually decreasing the initial bit rate, to determine the bit rate at which to compress the target data.

10. The method of claim 8, wherein said determining the bit rate includes determining a bit rate for each data file or each data stream contained in the target data when compressing the target data.

11. The method of claim 10, wherein said determining the bit rate includes determining a bit rate for each data file or each data stream contained in the target data according to a priority given to the data file or data stream when compressing the target data.

12. The method of claim 8, wherein said determining the bit rate includes determining the bit rate at which to compress the target data from among a plurality of bit rates prepared in advance.

13. The method of claim 8, wherein said determining the bit rate includes allocating the highest bit rate of the bit rates prepared in advance to the target data and gradually lowering the bit rate as available space in the storage medium reduces.

14. The method of claim 8, wherein said determining the bit rate includes recompressing data already stored in the storage medium at a lower bit rate, so that the target data is completely stored in the storage medium.
